(19) United States
(12) Patent Application Publication
(10) Pub. No.: US 2017/0002547 A1
(43) Pub. Date: Jan. 5, 2017

(54) OPERATION STATE DETECTION SYSTEM OF WORK MACHINE AND WORK MACHINE

(71) Applicant: KYB Corporation, Tokyo (JP)

(72) Inventor: Masaya OMOTE, Kanagawa (JP)

(73) Assignee: KYB Corporation, Tokyo (JP)

(21) Appl. No.: 15/125,886

(22) PCT Filed: May 20, 2015
(86) PCT No.: PCT/JP2015/064507

§ 371 Date: Sep. 13, 2016

(30) Foreign Application Priority Data
May 26, 2014 (JP) 2014-107755

(51) Int. Cl. E02F 9/26; G01B 11/24

(52) U.S. Cl. CPC E02F 9/264; G01B 11/24; E02F 3/32

(57) ABSTRACT

An operation state detection system of a work machine includes a recognition portion provided on a work portion, an image pickup device provided on a work machine body portion and configured to pick up an image of the work portion, a calculation portion configured to calculate change amounts when the shapes of the recognition portions in the image picked up by the image pickup device change with the operation of the work portion, and a detection portion configured to the operation state of the work portion on the basis of the change amounts calculated by the calculation portion.

### TECHNICAL FIELD

The present invention relates to an operation state detection system for detecting an operation state of a work machine and a work machine provided with the operation state detection system.

### BACKGROUND ART

In general, a work machine such as a hydraulic excavator is operated, while operators visually check an operation state of a work portion such as a bucket.

JP2009-287298A discloses a measuring device including a marker provided on a blade edge of a construction machine, the measuring device being configured to measure a position of the blade edge of the construction machine by a triangular surveying method from an image obtained by photographing the marker by using two cameras.

### SUMMARY OF INVENTION

However, with the measuring device of JP2009-287298A, since the triangular surveying method is used, two or more cameras are needed for measuring the blade edge position, which complicates constitution.

The present invention has an object to make detection of an operation state of a work machine possible with simple constitution.

According to one aspect of the present invention, an operation state detection system of a work machine for detecting an operation state of a work portion operated with respect to a work machine body portion includes a recognition portion provided on the work portion, an image pickup device provided on the work machine body portion, the image pickup device being configured to pick up an image of the work portion a calculation portion configured to calculate a change amount when a shape of the recognition portion in the image picked up by the image pickup device changes with an operation of the work portion, and a detection portion configured to detect the operation state of the work portion on the basis of the change amount calculated by the calculation portion.

### BRIEF DESCRIPTION OF DRAWINGS

FIG. 1 is a constitutional view of a work machine to which an operation state detection system of a work machine according to an embodiment of the present invention is applied.

FIG. 2 is a block diagram of the operation state detection system of the work machine.

FIG. 3 is a view illustrating an example of an image picked up by an image pickup device.

FIG. 4A is a view illustrating an example of a recognition portion mounted on a boom.

FIG. 4B is a view illustrating an example of the recognition portion mounted on an arm.

FIG. 4C is a view illustrating an example of the recognition portion mounted on a bucket.

FIG. 5A is a view for explaining a change in scale of the recognition portion.

FIG. 5B is a view for explaining a change in inclination of the recognition portion.

FIG. 5C is a view for explaining a change in strain of the recognition portion.

FIG. 6 is a flowchart of operation state detection control in the operation state detection system of a work machine.

### DESCRIPTION OF EMBODIMENTS

An operation state detection system of a work machine according to an embodiment of the present invention (hereinafter referred to simply as an “operation state detection system”) 100 and a hydraulic excavator 1 as a work machine provided with the operation state detection system 100 will be described below by referring to the attached drawings.

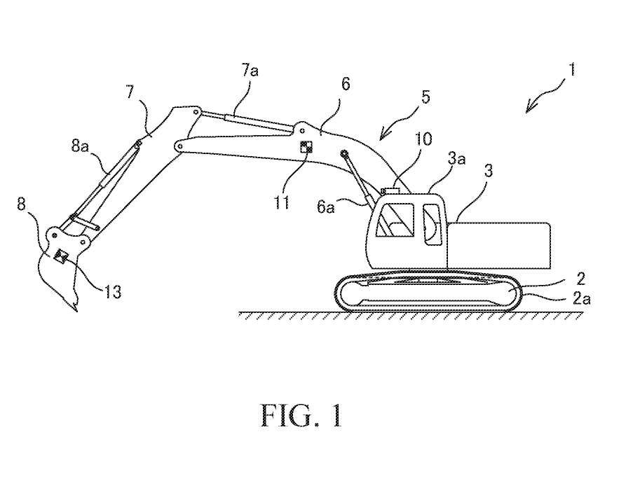

First, by referring to FIG. 1, constitution of the hydraulic excavator 1 will be described. Here, an example in which the work machine is the hydraulic excavator 1 will be described, but the operation state detection system 100 can be also applied to other work machines such as a hybrid excavator, a wheel loader and the like. Moreover, here, operating oil is used as an operating fluid, but other fluid such as working water may be used as the operating fluid.

The hydraulic excavator 1 includes a crawler-type traveling portion 2, a turning portion 3 as a work machine body portion provided rotatably on an upper part of the traveling portion 2, and an excavating portion 5 as a work portion provided on a front center part of the turning portion 3. The turning portion 3 has a cabin 3a on which an operator gets onboard.

The traveling portion 2 makes the hydraulic excavator 1 travel by driving a pair of right and left crawlers 2a by means of a traveling motor (not shown). The turning portion 3 is driven by means of a turning motor (not shown) and turns in right-and-left direction with respect to the traveling portion 2.

The excavating portion 5 includes a boom 6 mounted capable of swing around a horizontal axis extending in the right-and-left direction of the turning portion 3, an arm 7 mounted capable of swing at a tip end of the boom 6, and a bucket 8 mounted capable of swing at a tip end of the arm 7 and excavating earth and sand and the like. Moreover, the excavating portion 5 includes a boom cylinder 6a for vertically rotating the boom 6, an arm cylinder 7a for vertically rotating the arm 7, and a bucket cylinder 8a for rotating the bucket 8.

Subsequently, the operation state detection system 100 will be described by referring to FIGS. 1 to 4C.

The operation state detection system 100 detects an operation state of the excavating portion 5 operated with respect to the turning portion 3. The operation state detection system 100 includes recognition markers 11 to 13 as recognition portions provided on the excavating portion 5, a camera 10 as an image pickup device provided on the turning portion 3 to pick up an image of the excavating portion 5, a controller 20 that detects the operation state of the excavating portion 5 from the image picked up by the camera 10, and a monitor 30 as an information transmission portion for transmitting the operation state of the excavating portion 5 to an operator.

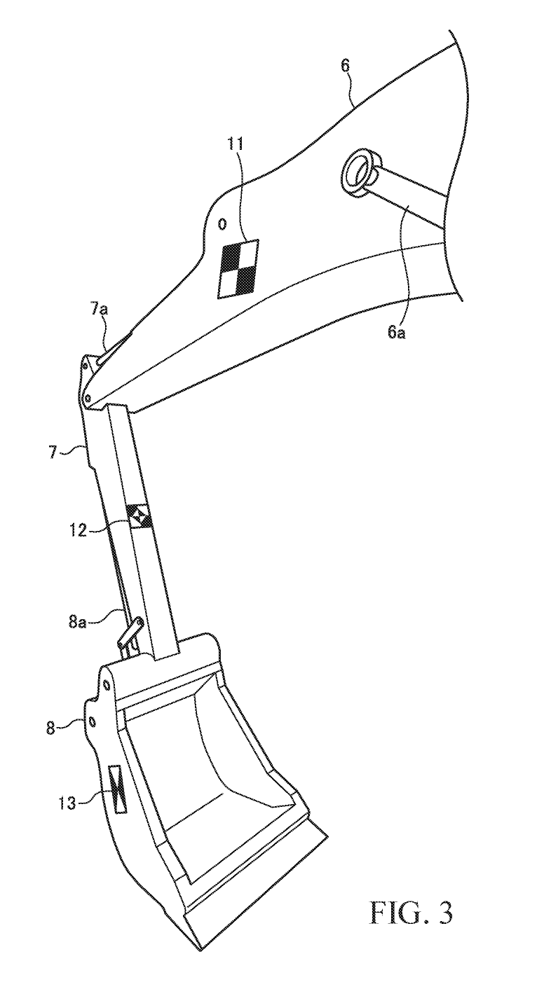

The camera 10 is provided at a position capable of picking up an image of the excavating portion 5 from a diagonally side position. An image pickup direction of the camera 10 is different from a plane on which the excavating portion 5 swings. This prevents the recognition marker 13 mounted on the bucket 8 from being hidden in a blind spot of the arm 7, for example. The camera 10 is provided on an upper part of the cabin 3a. Not only to that but the camera 10 may be provided at another position such as an inside of the cabin 3a. As illustrated in FIG. 3, the camera 10 is set so that all of the boom 6, the arm 7, and the bucket 8 of the excavating portion 5 are contained within a range capable of image pickup.

As illustrated in FIG. 3, the recognition marker 11 is mounted on a side surface of the boom 6. The recognition marker 12 is mounted on a lower surface of the arm 7. The recognition marker 13 is mounted on a side surface of the bucket 8. The recognition markers 11 to 13 are provided at positions capable of image pickup by the camera 10.

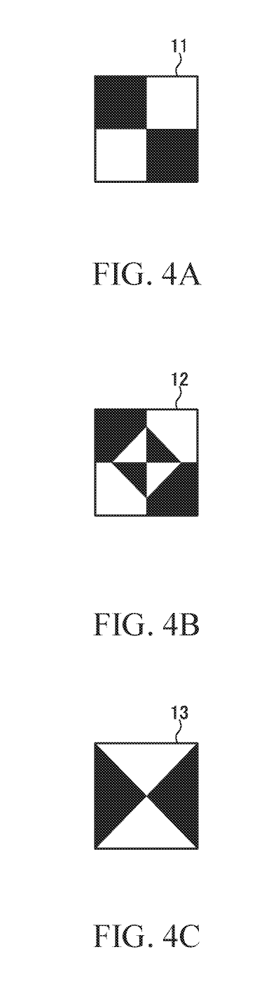

As illustrated in FIGS. 4A to 4C, the recognition markers 11 to 13 are formed so as to have square regions painted in black and white separately. The recognition markers 11 to 13 does not have to be regular squares but may be rectangles and the shape does not have to be a square as long as reference lines at a right angle formed by being painted in two or more colors can be recognized.

The recognition markers 11 to 13 are set to have different shapes, respectively. Thereby, the shapes of the recognition markers 11 to 13 are identified from the image picked up by the camera 10, and positions of the boom 6, the arm 7, and the bucket 8 can be individually detected. Thus, the operation states of a plurality of portions can be detected at the same time.

Not limited to that, the recognition markers 11 to 13 may have the same shape. Since movable ranges of the boom 6, the arm 7, and the bucket 8 are different from each other, even if the recognition markers 11 to 13 have the same shape, positions and attitudes of the boom 6, the arm 7, and the bucket 8 can be individually detected. Moreover, instead of mounting the recognition markers 11 to 13 on the boom 6, the arm 7, and the bucket 8, portions capable of recognizing the respective images may be used as recognition markers.

The controller 20 is constituted by a microcomputer including a CPU (central processing unit), a ROM (read-only memory), a RAM (random access memory), and an I/O interface (input/output interface). The RAM stores data in processing of the CPU, the ROM stores a control program and the like of the CPU in advance, and the I/O interface is used for input/output of information with connected devices.

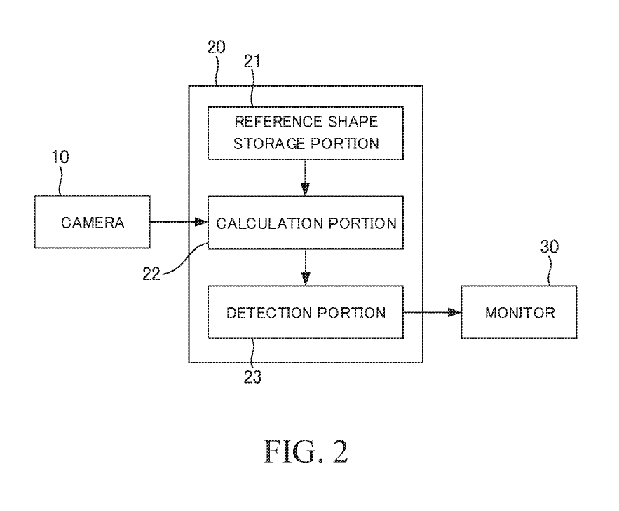

As illustrated in FIG. 2, the controller 20 includes a reference shape storage portion 21 that, in advance, stores reference shapes of the recognition markers 11 to 13 when the excavating portion 5 is at a reference position, a calculation portion 22 that calculates a change amount when the shapes of the recognition markers 11 to 13 in images that are picked up by the camera 10 change with the operation of the excavating portion 5, and a detection portion 23 that detects the operation state of the excavating portion 5 on the basis of the change amounts of the shapes of the recognition markers 11 to 13 calculated by the calculation portion 22.

The reference shape storage portion 21, as reference shapes, stores the positions and shapes of the recognition markers 11 to 13 which are picked up by the camera 10 in a state in which the excavating portion 5 is at a reference position. The reference shape storage portion 21 stores the reference shape of the recognition marker in a plurality of mountable work portions if the excavating portion 5 is replaceable with other work portions. Moreover, it also applies to a case in which a part of the work portion is replaceable such as a case in which only the bucket 8 can be replaced, for example.

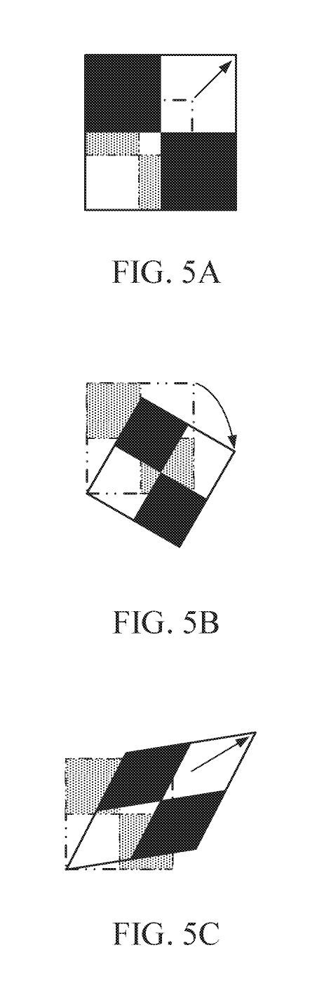

The calculation portion 22 calculates at least one of change amounts of the positions, the scales, the inclination, and the strains of the recognition markers 11 to 13 with respect to the reference shapes of the recognition markers 11 to 13 when the excavating portion 5 is at the reference position. Specifically, it is performed as follows. A shape indicated by a two-dot chain line in FIGS. 5A to 5C is the reference shape of the recognition marker 11.

The calculation portion 22 calculates a change amount between positions near and far of the excavating portion 5 on how much sizes of outer shapes of the recognition markers 11 to 13 are changed from the reference shapes as illustrated in FIG. 5A. The calculation portion 22 calculates a change of a rotation angle of the excavating portion 5 using an image pickup direction of the camera 10 as an axis on how much reference lines of the recognition markers 11 to 13 are inclined from the reference shapes as illustrated in FIG. 5B. The calculation portion 22 calculates the rotation angle of the excavating portion 5 using a perpendicular direction to the image pickup direction of the camera 10 as an axis on how much the outer shapes of the recognition markers 11 to 13 are strained from the reference shapes.

The detection portion 23 calculates a position of the excavating portion 5 to the turning portion 3 from the change amounts of the recognition markers 11 to 13. Changes of the positions of the boom 6, the arm 7, and the bucket 8 in the hydraulic excavator 1 have a correlation with the change amounts of the recognition markers 11 to 13. If the change amounts of the recognition markers 11 to 13 are known, the change of the positions of the boom 6, the arm 7, and the bucket 8 can be calculated.

The monitor 30 is provided in the cabin 3a on which the operator gets onboard in the turning portion 3. The monitor 30 is a display panel that displays the operation states of the boom 6, the arm 7, and the bucket 8 in the excavating portion 5 in an image. This enables the so-called informed operation in which the hydraulic excavator 1 is operated while the operator is watching the monitor 30. Instead of the monitor 30, a sound guide portion may be provided in order to notify the operator of the operation state of the excavating portion 5 in sound.

In addition, the monitor 30 may be provided on a separate body from the hydraulic excavator 1 so that the hydraulic excavator 1 can be remotely controlled from an outside. Moreover, the hydraulic excavator 1 may be made capable of automatic operation by feedback control using data displayed on the monitor 30.

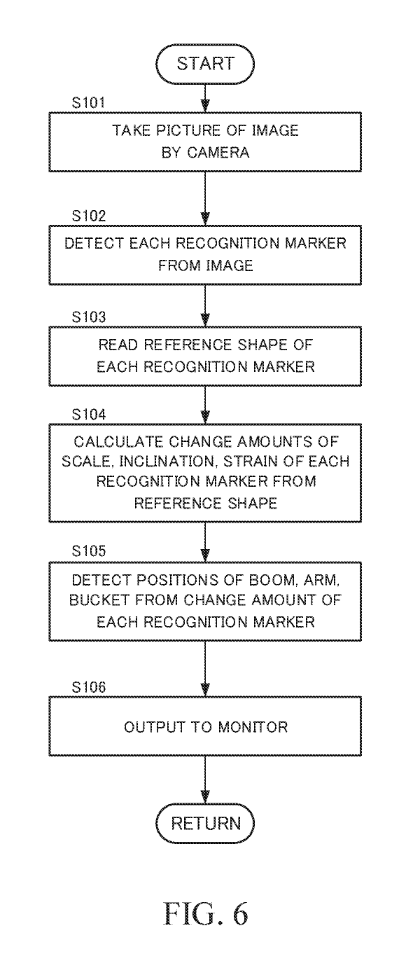

Subsequently, referring mainly to FIG. 6, operation state control of the hydraulic excavator 1 by the operation state detection system 100 will be described. The controller 20 repeatedly executes a routine illustrated in FIG. 6 during an operation of the hydraulic excavator 1 at a certain time interval such as every 10 milliseconds, for example.

At Step S101, an image is photographed by the camera 10. At this time, a still image may be photographed or one frame may be extracted as a still image from moving images.

At Step S102, from the image photographed at Step S101, the recognition markers 11 to 13 are detected by image recognition.

At Step S103, from the reference shape storage portion 21, the reference shapes of the recognition markers 11 to 13 are read.

At Step S104, the calculation portion 22 compares the recognition markers 11 to 13 detected at Step S102 with the reference shapes of the recognition markers 11 to 13 read at Step S103 and calculates change amounts of the positions, the scales, the inclination, and the strains of the recognition markers 11 to 13.

At Step S105, the detection portion 23 calculates the positions of the boom 6, the arm 7, and the bucket 8 from the change amounts of the recognition markers 11 to 13 calculated at Step S104. The positions of the boom 6, the arm 7, and the bucket 8 are the operation states of the excavating portion 5.

As described above, in the operation state detection system 100, the change amounts of the shapes of the recognition markers 11 to 13 which are provided on the excavating portion 5 are calculated from the image picked up by the camera 10, and the operation state of the excavating portion 5 is detected on the basis of the change amounts of the shapes of the recognition markers 11 to 13. Thus, the operation state of the excavating portion 5 can be detected only by the single camera 10 and the recognition markers 11 to 13. Therefore, the operation state of the hydraulic excavator 1 can be detected with simple constitution.

Moreover, since the operation state detection system 100 does not require various sensors such as a stroke sensor provided on each of the boom cylinder 6a, the arm cylinder 7a, and the bucket cylinder 8a of the excavating portion 5, and electric wiring for electrically connecting the various sensors and the controller 20, and the like, the operation state of the hydraulic excavator 1 can be detected with low-cost constitution.

At Step S106, the positions of the boom 6, the arm 7, and the bucket 8 calculated at Step S105 are output to the monitor 30. On the monitor 30, the operation states of the boom 6, the arm 7, and the bucket 8 in the excavating portion 5 are displayed as images. This enables the so-called informed operation in which the hydraulic excavator 1 is operated while the operator is watching the monitor 30.

The recognition markers 11 to 13 may be two-dimensional codes identifiable from the images picked up by the camera 10. Moreover, besides the recognition markers 11 to 13, a two-dimensional code may be mounted on the excavating portion 5. In this case, data specific to the excavating portion 5 such as lengths of the boom 6 and the arm 7 or a size of the bucket 8 in the excavating portion 5 can be stored in the two-dimensional code.

Thereby, even if the excavating portion 5 or a part of the excavating portion 5 is replaced, the controller 20 can automatically change setting from the data stored in the two-dimensional code. In addition, by storing data on a mounting position of the camera 10 in the two-dimensional code, it can be used for setting of the mounting position of the camera 10 such that an instruction to move the camera 10 to the right for 10 mm more, for example, is displayed on the monitor 30.

Moreover, the two-dimensional code has a recoverable error correction function if the error is approximately 7 to 30% even if the code is partially stained. Thus, if the two-dimensional code is applied to the recognition markers 11 to 13, some stains or breakage can be allowed, and detection accuracy can be improved.

According to the aforementioned embodiment, the following effects are exerted.

In the operation state detection system 100, from the image picked up by the camera 10, the change amounts of the shapes of the recognition markers 11 to 13 which are provided on the excavating portion 5 are calculated, and the operation state of the excavating portion 5 is detected on the basis of the change amounts of the shapes of the recognition markers 11 to 13. Thus, the operation state of the excavating portion 5 can be detected only by the single camera 10 and the recognition markers 11 to 13. Therefore, the operation state of the hydraulic excavator 1 can be detected with simple constitution.

Moreover, on the monitor 30, the operation states of the boom 6, the arm 7, and the bucket 8 in the excavating portion 5 are displayed on images. This enables the so-called informed operation in which the hydraulic excavator 1 is operated while the operator is watching the monitor 30.

Embodiments of this invention were described above, but the above embodiments are merely examples of applications of this invention, and the technical scope of this invention is not limited to the specific constitutions of the above embodiments.

This application claims priority based on Japanese Patent Application No.2014-107755 filed with the Japan Patent Office on May 26, 2014, the entire contents of which are incorporated into this specification.

1. An operation state detection system of a work machine for detecting an operation state of a work portion operated with respect to a work machine body portion, comprising:
a recognition portion provided on the work portion;
an image pickup device provided on the work machine body portion, the image pickup device being configured to pick up an image of the work portion;
a calculation portion configured to calculate a change amount when a shape of the recognition portion in the image picked up by the image pickup device changes with an operation of the work portion; and
a detection portion configured to detect the operation state of the work portion on the basis of the change amount calculated by the calculation portion.

2. The operation state detection system of a work machine according to claim 1, wherein
the calculation portion calculates at least one of the change amounts of a scale, inclination, and strain of the recognition portion.

3. The operation state detection system of a work machine according to claim 1, wherein
the calculation portion calculates the change amount of the recognition portion with respect to a reference shape of the recognition portion when the work portion is at a reference position; and
the detection portion detects a position of the work portion with respect to the work machine body portion from the change amount calculated by the calculation portion.

4. The operation state detection system of a work machine according to claim 1, wherein
the work machine is an excavator;
the work portion includes a boom swingably mounted with respect to the work machine body portion, an arm swingably mounted at a tip end portion of the boom, and a bucket swingably mounted at a tip end portion of the arm; and
the recognition portion is provided on the boom, the arm, and the bucket, respectively, and has shapes different from each other.

5. The operation state detection system of a work machine according to claim 4, wherein
the work machine body portion includes a cabin; and
the image pickup device is provided in the cabin of the excavator and has an image pickup direction different from a plane on which the work portion swings.

6. A work machine comprising the operation state detection system for a work machine according to claim 1.
